(19) United States
(12) Patent Application Publication
(10) Pub. No.: US 2025/0032924 A1
(43) Pub. Date: Jan. 30, 2025

(54) METHOD AND APPARATUS FOR CONTROLLING OBJECT IN VIRTUAL SCENE, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Ya ZHANG, Shenzhen (CN); Han WEN, Shenzhen (CN); Yiqi LI, Shenzhen (CN); Yinchao CHEN, Shenzhen (CN); Xiyang ZHOU, Shenzhen (CN); Luyu SUN, Shenzhen (CN)

(73) Assignee: TENCENT TECHNOLOGY (SHENZHEN) COMPANY LIMITED, Shenzhen, GD (CN)

(21) Appl. No.: 18/916,135

(22) Filed: Oct. 15, 2024

Related U.S. Application Data
(63) Continuation of application No. PCT/CN2023/101861, filed on Jun. 21, 2023.

(30) Foreign Application Priority Data
Aug. 23, 2022 (CN) 202211011679.5

(51) Int. Cl. A63F 13/56; A63F 13/52; A63F 13/58; A63F 13/87; G06T 17/00

(52) U.S. Cl. CPC A63F 13/56; A63F 13/52; A63F 13/58; A63F 13/87; G06T 17/00

(57) ABSTRACT

In a method for controlling a virtual object in a virtual scene which is displayed by a first terminal. A first account is logged in to the first terminal. The virtual scene includes at least one first virtual object at a first position and that is associated with the first account. An interaction invitation interface is displayed. An interaction request is transmitted to at least one second terminal in response to a trigger operation for the interaction invitation interface. Each of the second terminal is associated with a different second account. Each of at least one second virtual object is controlled to interact with the at least one first virtual object in response to an interaction request and based on whether a distance between a second position of the respective second virtual object and the first position is less than a first distance threshold.

### RELATED APPLICATIONS

The present application is a continuation of International Application No. PCT/CN2023/101861, filed on Jun. 21, 2023, which claims priority to Chinese Patent Application No. 202211011679.5, filed on Aug. 23, 2022. The entire disclosures of the prior applications are hereby incorporated by reference.

### FIELD OF THE TECHNOLOGY

This disclosure relates to human-machine interaction technologies, including to a method and an apparatus for controlling an object in a virtual scene, an electronic device, a computer-readable storage medium, and a computer program product.

### BACKGROUND OF THE DISCLOSURE

Display technologies based on graphics processing hardware have expanded channels for perceiving an environment and obtaining information. In particular, multimedia technologies for virtual scenes, with the help of human-machine interaction engine technologies, can implement diverse interactions between virtual objects controlled by users or artificial intelligence implemented according to actual application needs, and have various typical application scenarios. For example, in virtual scenes such as games, a real battle process between virtual objects can be simulated.

In a virtual scene, virtual objects need to interact with each other, where the interactions include, for example, a rescue operation between virtual objects, medical assistance between virtual objects, and a joint battle between virtual objects. However, the virtual objects may be at different positions in the virtual scene, making it difficult to achieve real-time interaction. This reduces efficiency of interaction in the virtual scene.

### SUMMARY

Embodiments of this disclosure provide a method and an apparatus for controlling an object in a virtual scene, an electronic device, a computer-readable storage medium, and a computer program product, to improve interaction efficiency by breaking through a space limitation of interaction between virtual objects.

An embodiment of this disclosure provides a method for controlling a virtual object, where the method is performed by an electronic device. In the method, a virtual scene is displayed by a first terminal. A first account is logged in to the first terminal, and the virtual scene includes at least one first virtual object at a first position and that is associated with the first account. An interaction invitation interface is displayed. An interaction request is transmitted to at least one second terminal in response to a trigger operation being performed on the interaction invitation interface. Each of the at least one second terminal is associated with a different second account. Each of at least one second virtual object is controlled to interact with the at least one first virtual object in response to the interaction request and based on whether a distance between a second position of the respective second virtual object and the first position is less than a first distance threshold.

An embodiment of this disclosure provides an apparatus. The apparatus includes processing circuitry configured to display a virtual scene. A first account is logged in to the apparatus. The virtual scene includes at least one first virtual object at a first position and that is associated with the first account. The processing circuitry is configured to display an interaction invitation interface. The processing circuitry is configured to transmit an interaction request to at least one second terminal in response to a trigger operation being performed on the interaction invitation interface. Each of the second terminal is associated with a different second account. The processing circuitry is configured to control each of at least one second virtual object to interact with the at least one first virtual object in response to the interaction request and based on whether a distance between a second position of the respective second virtual object and the first position is less than a first distance threshold.

An embodiment of this disclosure provides a method for controlling an object in a virtual scene, where the method is performed by an electronic device. The method includes:
displaying a virtual scene in a human-machine interaction interface of a second terminal, a second account being logged in to the second terminal;
displaying an interaction request transmitted by a first terminal, a first account being logged in to the first terminal; and
controlling, in response to a confirm operation for the interaction request, at least one second virtual object associated with the second account to appear from a second position and interact with at least one first virtual object associated with the first account, a distance between the second position and a first position being less than a first distance threshold.

An embodiment of this disclosure provides an apparatus for controlling an object in a virtual scene. The apparatus includes:
a third display module, configured to display the virtual scene in a human-machine interaction interface of a second terminal, a second account being logged in to the second terminal;
a receiving module, configured to display an interaction request transmitted by a first terminal, a first account being logged in to the first terminal; and
a second interaction module, configured to control, in response to a confirm operation for the interaction request, at least one second virtual object associated with the second account to appear from a second position and interact with at least one first virtual object associated with the first account, a distance between the second position and a first position being less than a first distance threshold.

An embodiment of this disclosure provides an electronic device, including:
a memory, configured to store executable instructions; and
a processor, configured to perform the method for controlling an object in a virtual scene provided in the embodiments of this disclosure when executing the executable instructions stored in the memory.

An embodiment of this disclosure provides a non-transitory computer-readable storage medium having executable instructions stored therein, the executable instructions, when executed by a processor, implementing the method for controlling an object in a virtual scene provided in the embodiments of this disclosure.

An embodiment of this disclosure provides a computer program product, including a computer program or computer-executable instructions, the computer program or the computer-executable instructions, when executed by a processor, implementing the method for controlling an object in a virtual scene provided in the embodiments of this disclosure.

The embodiments of this disclosure have the following beneficial effects:

The first account associated with the first virtual object is logged in to the first terminal. The first terminal transmits the interaction request to the second terminal. In response to that the second account being logged in to the second terminal receives the interaction request, the second virtual object associated with the second account appears near the first virtual object, and interacts with the first virtual object, which is equivalent to breaking through a distance limitation of inviting other virtual objects to interact, so that the second virtual object appears near the first virtual object in real time. Compared with a manner moving in the virtual scene, this can improve interaction efficiency and human-machine interaction efficiency in the virtual scene.

### BRIEF DESCRIPTION OF THE DRAWINGS

FIG. 1 is a schematic diagram of an application mode of a method for controlling an object in a virtual scene according to an embodiment of this disclosure.

FIG. 2A and FIG. 2B are schematic structural diagrams of an electronic device according to an embodiment of this disclosure.

FIG. 3A to FIG. 3E are schematic flowcharts of a method for controlling an object in a virtual scene according to an embodiment of this disclosure.

FIG. 4 is a schematic diagram of an interface of a method for controlling an object in a virtual scene according to an embodiment of this disclosure.

FIG. 5 is a schematic diagram of an interface of a method for controlling an object in a virtual scene according to an embodiment of this disclosure.

FIG. 6 is a schematic diagram of an interface of a method for controlling an object in a virtual scene according to an embodiment of this disclosure.

FIG. 7 is a schematic diagram of an interface of a method for controlling an object in a virtual scene according to an embodiment of this disclosure.

FIG. 8 is a schematic flowchart of a method for controlling an object in a virtual scene according to an embodiment of this disclosure.

FIG. 9 is a schematic diagram of positioning of a method for controlling an object in a virtual scene according to an embodiment of this disclosure.

FIG. 10 is a schematic diagram of an interface of a method for controlling an object in a virtual scene according to an embodiment of this disclosure.

FIG. 11 is a schematic diagram of an interface of a method for controlling an object in a virtual scene according to an embodiment of this disclosure.

### DETAILED DESCRIPTION

To make the objectives, technical solutions, and advantages of this disclosure clearer, the following describes this disclosure in further detail with reference to the accompanying drawings. The described embodiments are not to be considered as a limitation to this disclosure. Other embodiments obtained by a person of ordinary skill in the art shall fall within the protection scope of this disclosure.

In the following descriptions, the related term “first/second/third” is merely intended to distinguish between similar objects but does not necessarily indicate a specific order of an object. The “first/second/third” is interchangeable in terms of a specific order or sequence if permitted, so that the embodiments of this disclosure described herein can be implemented in a sequence in addition to the sequence shown or described herein. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used in this specification are the same as those usually understood by a person skilled in the art. Terms used in this specification are merely intended to describe objectives of the embodiments of this disclosure, but are not intended to limit this disclosure.

Before the embodiments of this application are further described in detail, examples of terms involved in the embodiments of this disclosure are described. The descriptions of the terms are provided as examples only and are not intended to limit the scope of the disclosure.

(1) Virtual scene: It is a scene outputted by a device and different from the real world. Visual perception of the virtual scene can be formed with the aid of naked eyes or devices, for example, by using two-dimensional images outputted by a display screen or three-dimensional images outputted by using a three-dimensional display technology such as a three-dimensional projection, virtual reality, or augmented reality technology. In addition, a variety of perception simulating the real world such as auditory perception, tactile perception, olfactory perception, and motion perception can further be formed by using a variety of possible hardware.

For example, in practical application, an application supporting a virtual scene is installed and run on a terminal. The application may be any one of a first-person shooting (FPS) game, a third-person shooting game, a driving game with steering operations as the dominant behavior, a multiplayer online battle arena (MOBA) game, a two-dimensional (2D) game application, a three-dimensional (3D) game application, a virtual reality application, a three-dimensional map program, or a multiplayer survival game. The application may alternatively be a standalone application, such as a standalone 3D game program.

(2) “In response to”: It is used for representing a condition or status on which a to-be-performed operation depends. When the condition or status is satisfied, one or more operations may be performed in real time or after a set delay. Unless otherwise specified, there is no limitation on a sequence in which a plurality of operations are performed.

(3) Client: It is an application providing various services run in the terminal, such as a game client.

(4) Cloud storage: It is a new concept extended and developed from the concept of cloud computing. It is a system that collects a large number of different types of storage devices in a network through application software to work together and jointly provide data storage and service access functions to the outside world through functions such as clustering applications, grid technology, or distributed file systems. When a core of operation and processing of the cloud computing system is storage and management of a large amount of data, a large number of storage devices need to be configured in the cloud computing system, and the cloud computing system becomes a cloud storage system. Therefore, the cloud storage is a cloud computing system with data storage and management as a core.

In strategy games in the related art, to send an interaction request to others, for example, an assistance request, assistance request information needs to be sent. After receiving the assistance request, if others agree to assist in the battle, a virtual object needs to be selected in the game. The virtual object is then dragged, or the virtual object is driven to move forward after a target destination is selected. The team needs to march for an actual distance on a map in the game. Therefore, it takes much time to reach the designated target destination. If the actual distance is large, the march takes a long time. There is a problem that the virtual object for assisting cannot arrive quickly. Interactions in the related art need to depend on actual travel on a map. In the embodiments of this disclosure, a distance limitation is broken through, a virtual object participating an interaction directly appears near a virtual object that sends an assistance request, and a quick interaction can be implemented.

The embodiments of this disclosure provide a method and an apparatus for controlling an object in a virtual scene, an electronic device, a computer-readable storage medium, and a computer program product, which can break through a space limitation of inviting other virtual objects for interaction, and directly appear near the virtual objects, improving interaction efficiency. An example application of the electronic device provided in the embodiments of this disclosure is described below. The electronic device provided in the embodiments of this disclosure may be implemented as various types of terminal devices such as a notebook computer, a tablet computer, a desktop computer, a set-top box, or a mobile device (for example, a mobile phone, a portable music player, a personal digital assistant, a dedicated messaging device, or a portable game device).

For ease of understanding the method for controlling an object in a virtual scene provided in the embodiments of this disclosure, an example implementation scenario of the method for controlling an object in a virtual scene provided in the embodiments of this disclosure is first described. The virtual scene may be outputted based on a terminal, or outputted based on cooperation between a terminal and a server.

In some embodiments, the virtual scene may be an environment for game characters to interact, for example, the game characters may battle with each other in the virtual scene.

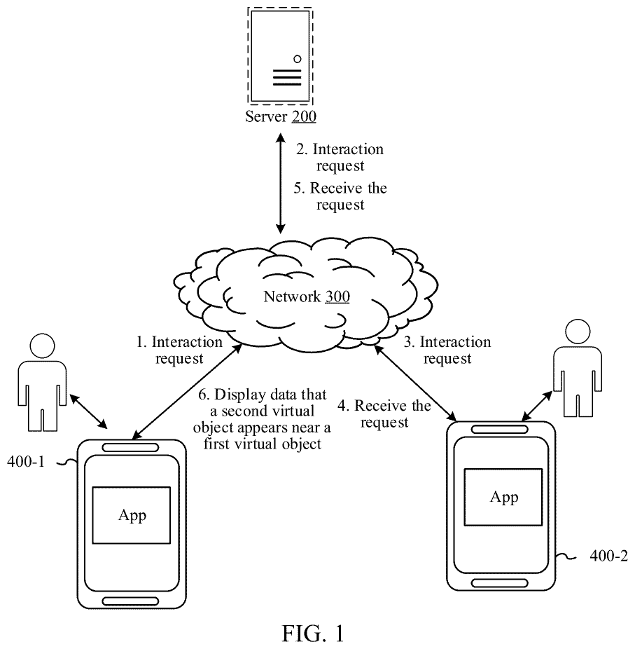

In another implementation scenario, FIG. 1 is a schematic diagram of an application mode of a method for controlling an object in a virtual scene according to an embodiment of this disclosure. The method is applied to a first terminal 400-1, a second terminal 400-2, and a server 200, and generally, applicable to an application mode in which virtual scene calculation is completed relying on computing power of the server 200, and the virtual scene is outputted on the first terminal 400-1 and the second terminal 400-2.

In an example, a first account is logged in to a client (for example, an online game application) run on the first terminal 400-1. A virtual scene is displayed in a human-machine interaction interface of the first terminal. The virtual scene includes at least one first virtual object associated with the first account, and the at least one first virtual object is at a first position. An interaction invitation portal is displayed on the first terminal 400-1. In response to a trigger operation for the interaction invitation portal, the first terminal 400-1 transmits an interaction request to the second terminal 400-2 by the server 200. A second account is logged in to the second terminal. In response to that the second account receives the interaction request, the second terminal 400-2 transmits an interaction reception instruction to the server 200. At least one second virtual object associated with the second account is generated by the server 200 at a second position near the first virtual object, and interacts with the at least one first virtual object. The server 200 transmits display data that the second virtual object appears at the second position and display data that the second virtual object interacts with the first virtual object to the first terminal 400-1 and the second terminal 400-2.

In some embodiments, the first terminal 400-1 and the second terminal 400-2 can implement the method for controlling an object in a virtual scene provided in the embodiments of this disclosure by executing a computer program. For example, the computer program may be an original program or software module in an operating system, may be a native application (APP), namely, a program that needs to be installed in the operating system for running, such as a game APP (namely, the foregoing client) or a live streaming APP, may be a mini program, namely, a program that only needs to be downloaded to a browser environment for running, or may be a game mini program that can be embedded into any APP. In conclusion, the computer program may be an application, a module, or a plug-in in any form.

The embodiments of this disclosure may be implemented by using a cloud technology. The cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. The cloud computing technology becomes an important support. A background service of a technical network system needs a large number of computing and storage resources.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In an example, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smartwatch, or the like, but is not limited thereto. The terminal and the server 200 may be directly or indirectly connected in a wired or wireless communication manner. This is not limited in this embodiment of this disclosure.

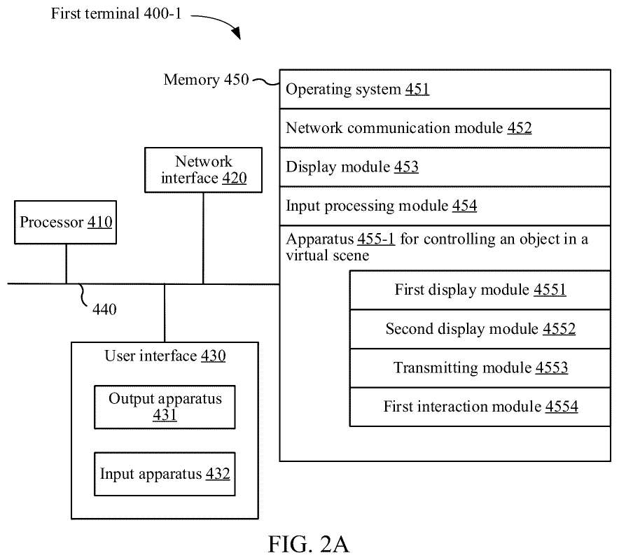

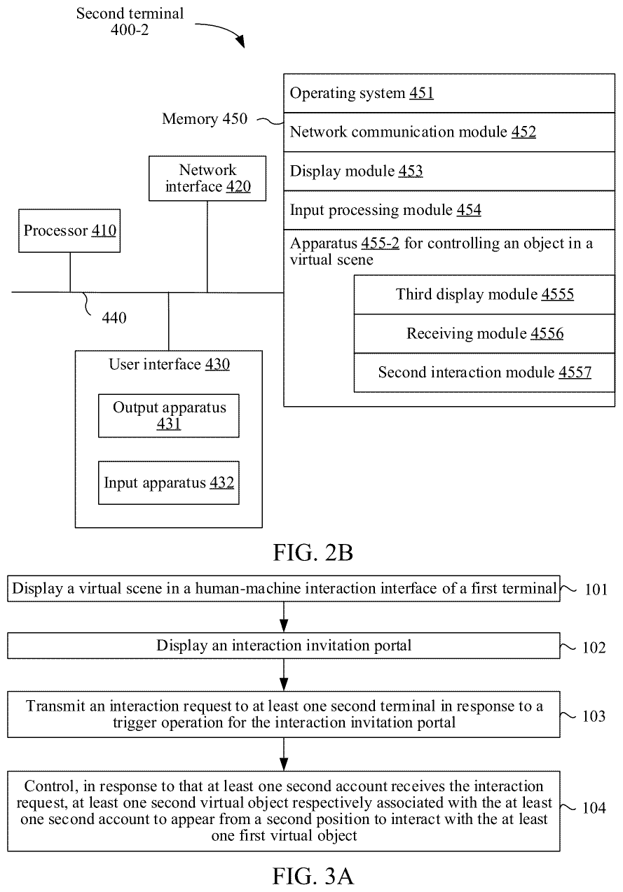

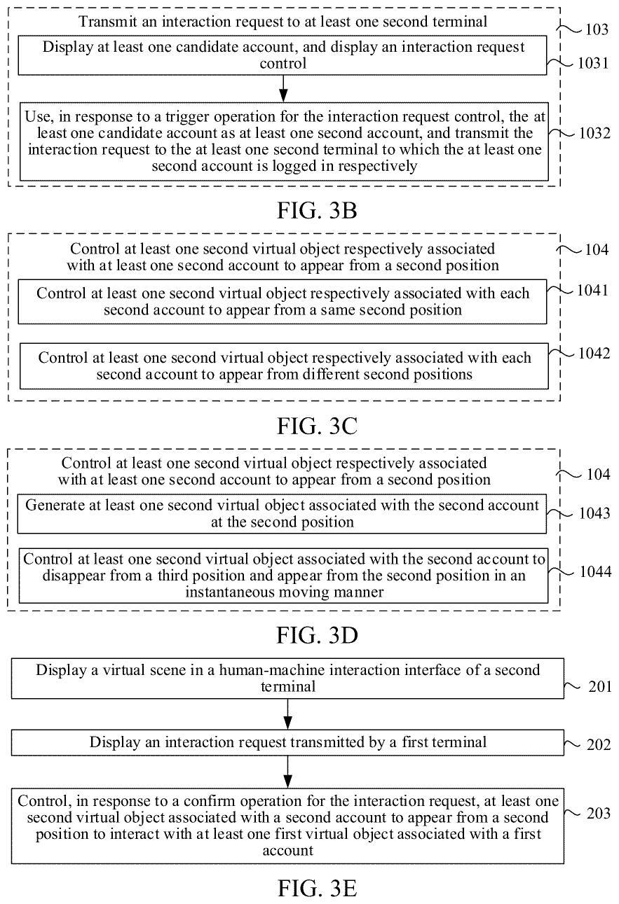

FIG. 2A is a schematic structural diagram of an electronic device used in a method for controlling an object in a virtual scene according to an embodiment of this disclosure. An example in which the electronic device is a terminal is used for description. The first terminal 400-1 shown in FIG. 2A includes: at least one processor 410, a memory 450, at least one network interface 420, and a user interface 430. All components in the first terminal 400-1 are coupled together by a bus system 440. The bus system 440 is configured to implement connection and communication between the components. In addition to a data bus, the bus system 440 further includes a power bus, a control bus, and a state signal bus. However, for ease of clear description, all types of buses in FIG. 3 are marked as the bus system 440.

Processing circuitry, such as the processor 410 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The user interface 430 includes one or more output apparatuses 431 that can display media content, including one or more speakers and/or one or more visual display screens. The user interface 430 further includes one or more input apparatuses 432, including user interface components that facilitate user input, such as a keyboard, a mouse, a microphone, a touch display screen, a camera, and other input buttons and controls.

The memory 450 may be a removable memory, a non-removable memory, or a combination thereof. For example, hardware devices include a solid-state memory, a hard disk drive, an optical disc driver, or the like. The memory 450 may include one or more storage devices physically away from the processor 410.

The memory 450, such as a non-transitory computer-readable storage medium, includes a volatile memory or a non-volatile memory, or may include both a volatile memory and a non-volatile memory. The non-volatile memory may be a read-only memory (ROM). The volatile memory may be a random access memory (RAM). The memory 450 described in this embodiment of this disclosure is to include any suitable type of memory.

In some embodiments, the memory 450 can store data to support various operations. Examples of the data include a program, a module, and a data structure, or a subset or a superset thereof, which are described below by using examples.

An operating system 451 includes a system program configured to process various basic system services and perform a hardware-related task, such as a framework layer, a core library layer, or a driver layer, and is configured to implement various basic services and process a hardware-based task.

A network communication module 452 is configured to reach another electronic device through one or more (wired or wireless) network interfaces 420. Example network interfaces 420 include: Bluetooth, wireless compatible authentication (Wi-Fi), a universal serial bus (USB), and the like.

A display module 453 is configured to display information by using one or more output apparatuses 431 (for example, a display screen and a speaker) associated with the user interface 430 (for example, a user interface configured to operate a peripheral device and display content and information).

An input processing module 454 is configured to detect one or more user inputs or interactions from one of the one or more input apparatuses 432 and translate the detected input or interaction.

In some embodiments, an apparatus for controlling an object in a virtual scene provided in the embodiments of this disclosure may be implemented in a software manner. FIG. 2A shows an apparatus 455-1 for controlling an object in a virtual scene stored in the memory 450. The apparatus may be software in a program or plug-in form, and includes the following software modules: a first display module 4551, a second display module 4552, a transmitting module 4553, and a first interaction module 4554. A structure of the second terminal 400-2 shown in FIG. 2B is the same as that of the electronic device shown in FIG. 2A. FIG. 2B further shows an apparatus 455-2 for controlling an object in a virtual scene stored in the memory 450. The apparatus may be software in a program or plug-in form, and includes the following software modules: a third display module 4555, a receiving module 4556, and a second interaction module 4557. These modules are logical, and can be combined or further split according to functions implemented by the modules. The following describes functions of the modules.

The method for controlling an object in a virtual scene provided in the embodiments of this disclosure is described with reference to example and implementation of the terminal provided in the embodiments of this disclosure.

The following describes the method for controlling an object in a virtual scene provided in the embodiments of this disclosure. As described above, the electronic device implementing the method for controlling an object in a virtual scene provided in the embodiments of this disclosure may be a terminal device. Therefore, an execution entity performing operations is not repeated below.

FIG. 3A is a schematic flowchart of a method for controlling an object in a virtual scene according to an embodiment of this disclosure, which is described with reference to operation 101 to operation 104 shown in FIG. 3A.

Operation 101: Display a virtual scene in a human-machine interaction interface of a first terminal.

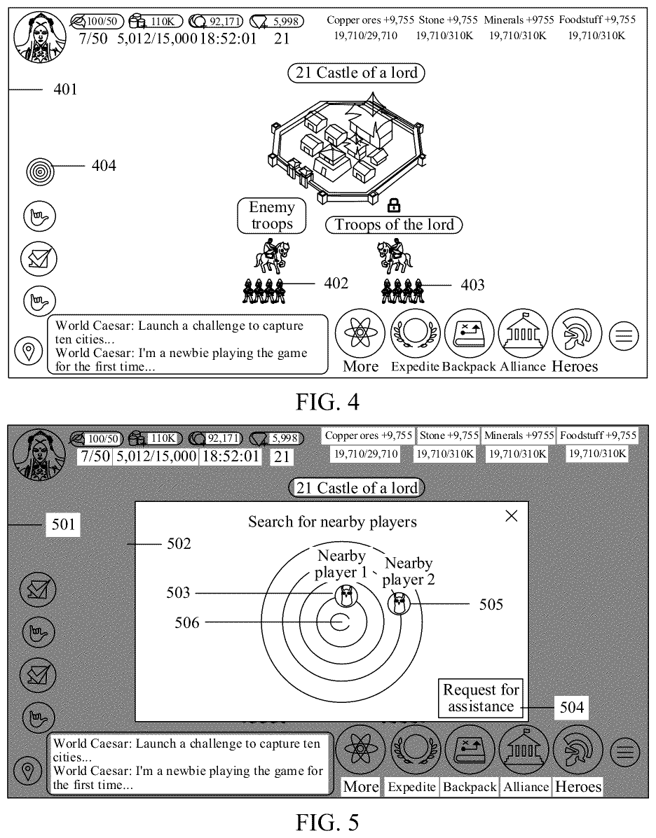

In an example, a first account is logged in to the first terminal, the virtual scene includes at least one first virtual object associated with the first account, and the at least one first virtual object is at a first position. Referring to FIG. 4, a human-machine interaction interface 401 displays a first virtual object 403 that is being attacked by a third virtual object 402. The first virtual object may be one virtual object or may be a plurality of virtual objects. In other words, the first virtual object may be an individual, or may be all individuals belonging to a team. When there is one first virtual object, the first position is a position which one first virtual object is at; and when there are a plurality of first virtual objects, the first virtual objects are at respective first positions, that is, there are a plurality of first positions. At least two of the plurality of first positions may be the same, or all the first positions may be different.

Operation 102: Display an interaction invitation portal.

In an example, the interaction invitation portal may be a battle assistance request portal. Referring to FIG. 4, the human-machine interaction interface 401 further displays a battle assistance request portal 404. According to different interaction needs of users, the interaction invitation portal may have different types. The interaction invitation portal includes, but is not limited to, at least one of the following: a battle assistance request portal, a medical assistance request portal, a joint battle portal, a shared equipment portal, or the like. The interaction invitation portal being the battle assistance request portal is mainly used as an example for subsequent description. Different interaction invitation portals transmit different interaction requests after being triggered. For example, the medical assistance request portal transmits a medical assistance request (an interaction request) after being triggered, to request a second virtual object to provide medical assistance for the first virtual object.

Operation 103: Transmit an interaction request to at least one second terminal in response to a trigger operation for the interaction invitation portal.

Following the foregoing example, different second accounts are logged in to different second terminals. When the interaction invitation portal is the battle assistance request portal, the interaction request is an assistance request. After transmitting a trigger operation for the battle assistance request portal 404 in FIG. 4, the first account may transmit an assistance request to another player (the second account), that is, transmit the assistance request to the second terminal to which the second account is logged in. When there are a plurality of second accounts, the assistance request is transmitted to the second terminal to which each second account is logged in.

Operation 104: Control, in response to that at least one second account receives the interaction request, at least one second virtual object respectively associated with the at least one second account to appear from a second position and interact with the at least one first virtual object, a distance between the second position and the first position being less than a first distance threshold.

In an example, the first distance threshold is a minimum distance at which the second virtual object cannot interact with the first virtual object, and indicates that once the distance between the second virtual object and the first virtual object reaches the first distance threshold, the second virtual object cannot interact with the first virtual object.

In an example, when the first account controls one first virtual object, the first position is a specific set of first coordinates of the first virtual object in the virtual scene. When the first account controls a plurality of first virtual objects (a first team), the first position is a place in which each first virtual object in the first team is located. When the second account controls one second virtual object, the second position is a specific set of second coordinates of the second virtual object in the virtual scene. When the second account controls a plurality of second virtual objects (a second team), the second position is a place in which each second virtual object in the second team is located. There may be one or more second accounts. When there are a plurality of second accounts, each second account is associated with at least one second virtual object.

In an example, for each second account, when there is one first virtual object, and there is one second virtual object associated with the second account, the distance between the first position and the second position is a distance between the first coordinates and the second coordinates. When there are a plurality of first virtual objects, and there is one second virtual object associated with the second account, the distance between the first position and the second position is a distance between a geometric center of a plurality of sets of first coordinates and the second coordinate. When there is one first virtual object, and there are a plurality of second virtual objects associated with the second account, the distance between the first position and the second position is a distance between a geometric center of a plurality of sets of second coordinates and the first coordinates. When there are a plurality of first virtual objects, and there are a plurality of second virtual objects associated with the second account, the distance between the first position and the second position is a distance between a geometric center of a plurality of sets of second coordinates and a plurality of sets of first coordinates.

In some embodiments, the displaying the interaction invitation portal in operation 102 may be implemented through the following technical solution: performing any one of the following processing: displaying the interaction invitation portal in the human-machine interaction interface when an interaction condition is satisfied; or continuously displaying the interaction invitation portal in the human-machine interaction interface, and in a process of continuously displaying the interaction invitation portal, highlighting the interaction invitation portal when the interaction condition is satisfied. In the embodiments of this disclosure, the interaction invitation portal is conditionally displayed, so that display resources can be saved. In the embodiments of this disclosure, the interaction invitation portal is highlighted, thereby achieving a prompt effect and improving human-machine interaction efficiency.

In an example, the interaction invitation portal may be displayed in the entire game battle process. When the interaction condition is satisfied, the interaction invitation portal is highlighted, for example, enlarged and displayed, or a light circle is added around a control. An interaction invitation portal 1001 shown in FIG. 10 is in a highlighted state, thereby achieving a prompt effect, to prompt a user of the first account can use an invitation interaction function. The interaction invitation portal may alternatively be displayed in the human-machine interaction interface only when the interaction condition is satisfied, to save the display resources.

In some embodiments, the interaction condition includes at least one of the following: a total health point of the at least one first virtual object is less than a health threshold; the at least one first virtual object is in an attacked state, and a number of attacking objects exceeds a first number threshold; the at least one first virtual object is in a battle interaction victory state; or a number of virtual items to be picked up in the virtual scene exceeds a second number threshold. In this embodiment of this disclosure, the interaction condition may be combined with real-time battle data in the virtual scene, so that the interaction invitation portal is displayed when the first virtual object needs assistance, improving the human-machine interaction efficiency.

In an example, if there is one first virtual object, the total health point is a health point of one first virtual object. The health point is configured to measure a survival status of the virtual object. If the health point is low, it indicates that the virtual object is about to die. If there are a plurality of first virtual objects, the total health point is a sum of health points of the plurality of first virtual objects. In this case, the interaction invitation portal is displayed, or the interaction invitation portal is highlighted, prompting an interaction invitation for the first account to seek medical assistance from the second account.

In an example, the at least one first virtual object is in an attacked state, and a number of attacking objects exceeds a first number threshold, indicating that the first virtual object is being attacked by the attacking objects, and the number of attacking objects is large. The first number threshold is a number of attacking objects required when combat powers of the first virtual object and the attacking objects are the same in a current battle situation. In this case, the first account needs to transmit a battle assistance request to another account. Therefore, the interaction invitation portal is displayed, or the interaction invitation portal is highlighted, prompting an interaction invitation for the first account to seek battle assistance from the second account.

In an example, the at least one first virtual object is in a battle interaction victory state, indicating that other players can be invited to celebrate the victory of the battle. The second number threshold is a maximum number of virtual items that the first virtual object can pick up. The number of virtual items to be picked up in the virtual scene exceeds a second number threshold indicates that other players can be invited to pick up the virtual items in this case.

In some embodiments, FIG. 3B is a schematic flowchart of a method for controlling an object in a virtual scene according to an embodiment of this disclosure. The transmitting the interaction request to at least one second terminal in operation 103 may be implemented through operation 1031 and operation 1032 in FIG. 3B.

Operation 1031: Display at least one candidate account, and display an interaction request control.

Operation 1032: Use, in response to a trigger operation for the interaction request control, the at least one candidate account as at least one second account, and transmit the interaction request to the at least one second terminal to which the at least one second account is logged in respectively.

In this embodiment of this disclosure, all candidate accounts may be used as second accounts, and the interaction request may be transmitted at one time through trigger of the interaction request control.

In an example, referring to FIG. 5, after the first account transmits a trigger operation for the battle assistance request portal 404 in FIG. 4, account profile pictures 503 and 505 (profile pictures of candidate accounts) of two other players and an interaction request control 504 are displayed. In response to the trigger operation by the first account for the interaction request control 504, all the candidate accounts may be used as the second accounts, and the interaction request, for example, an assistance request, is transmitted to a second terminal of each second account.

In some embodiments, the transmitting the interaction request to the at least one second terminal in operation 103 may be implemented through the following technical solution: displaying at least one candidate account, and displaying an interaction request control; displaying, in response to a selecting operation for at least one candidate account or that at least one candidate account satisfies an automatic selection condition, that the at least one candidate account is in a selected state; and using, in response to a trigger operation for the interaction request control, the candidate account in the selected state as a second account, and transmitting the interaction request to the at least one second terminal to which the at least one second account is logged in. In the embodiments of this disclosure, the second account in the candidate accounts can be selectively determined, and then the interaction request is transmitted for the second account, improving utilization of communication resources.

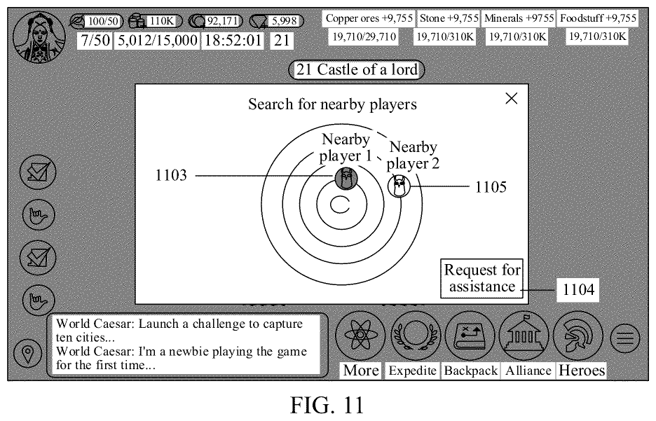

In an example, referring to FIG. 11, after the first account transmits a trigger operation for the battle assistance request portal 404 in FIG. 4, a candidate account 1103, a candidate account 1105, and an interaction request control 1104 are displayed. The candidate account 1103 is automatically in a selected state, or is in a selected state after being manually selected. In response to the trigger operation by the first account for the interaction request control 1104, the candidate account 1103 may be used as the second account, and the interaction request, for example, an assistance request, is transmitted to a second terminal of the candidate account 1103.

In some embodiments, before displaying the at least one candidate account, a candidate account satisfying at least one of the following screening conditions is obtained; a distance between a terminal to which a candidate account is logged in and the first terminal is less than a second distance threshold; a candidate account having a social relationship with the first account; a candidate account having a historical interaction event with the first account in the virtual scene, the historical interaction event including a historical battle assistance event, a historical medical assistance event, or the like; or a distance between a candidate virtual object associated with the at least one candidate account and the at least one first virtual object is less than a third distance threshold, indicating that the candidate virtual object is relatively close to the first virtual object in the virtual scene. The third distance threshold is an average value of distances between other virtual objects than the first virtual object and the first virtual object. Therefore, a player controlling the candidate virtual object is aware of the environment in which the first virtual object is located, so that the candidate virtual object and the first virtual object can interact more efficiently.

In an example, the distance between the terminal to which the candidate account is logged in and the first terminal is less than the second distance threshold, indicating that an offline distance between two players are close. This may be used as a screening condition to promote mutual assistance between offline players. The second distance threshold may be a maximum distance threshold for short-range communication. The account having a social relationship with the first account is used as a social account, so that a range of interaction between players can be extended, and game interaction is transitioned to social interaction.

In some embodiments, before the at least one candidate account is displayed, environment data of the virtual scene and object data of at least one virtual object associated with each participating account in the virtual scene are obtained; and a first neural network model is invoked to perform the following processing: extracting an environment feature from the environment data, and extracting an object feature from the object data; merging the environment feature and the object feature, to obtain a first merged feature; and mapping the first merged feature into a first probability of each participating account responding to the interaction request, and using a participating account whose first probability is greater than a first probability threshold as the candidate account. In this way, the first neural network model can learn a current status of the virtual object and a current environment of the virtual scene, to accurately predict the first probability of each participating account responding the interaction request based on learned information. Because the first probability can be accurately predicted, a candidate account that is more likely to respond to the interaction request can be displayed, avoiding reducing the human-machine interaction efficiency and wasting the communication resources because no one responds to the interaction request transmitted by the first account.

In an example, the environment data is configured for indicating topography of the virtual scene, and the object data is configured for indicating a current status of the virtual object, for example, a health point and a skill. Sample object data of a sample account is acquired in a sample virtual scene, and sample environment data is acquired in the sample virtual scene. A training sample is built according to the acquired data, the training sample is used as an input of a to-be-trained first neural network model, and whether the account responds to an interaction request is used as annotation data. When the account responds to the interaction request, the annotation data is 1; and when the account does not respond to the interaction request, the annotation data is 0. The first neural network model is trained based on the training sample and the annotation data, so that whether an account is used as a candidate account for display can be directly determined by using the first neural network model.

In some embodiments, when there are a plurality of candidate accounts, the displaying at least one candidate account may be implemented through the following technical solution: performing any one of the following processing: displaying the plurality of candidate accounts in ascending order of physical distances between the plurality of candidate accounts and the first account, the physical distance between the candidate account and the first account being a distance between a candidate terminal to which the candidate account is logged in and the first terminal, the plurality of candidate accounts being arranged and displayed in ascending order of physical distances can prompt the user to first transmit the interaction request to a player nearby, to combine the online game with offline interaction, thereby improving interaction diversity; displaying the plurality of candidate accounts in ascending order of social distances between the plurality of candidate accounts and the first account, displaying the plurality of candidate accounts in ascending order of social distances can prompt the user to first transmit the interaction request to a player with a closer relationship, to extend an interaction range from a game scenario to a social scenario, thereby effectively improving interaction diversity; displaying the plurality of candidate accounts in descending order of network signal strengths of terminals to which the plurality of candidate accounts are logged in, to prompt the user to first transmit the interaction request to a candidate account with a stronger network signal, to ensure network smooth of subsequent interactions, thereby ensuring highly efficient interaction; or displaying candidate accounts in descending order of significance degrees of the candidate accounts.

In addition, the significance degree of the candidate account is negatively correlated to a feature parameter of the candidate account. The feature parameter includes at least one of the following: the physical distance between the terminal to which the candidate account is logged in and the first terminal, the social distance between the candidate account and the first account, or the distance between the candidate virtual object associated with the candidate account and the first virtual object. For example, a candidate account with a shorter physical distance has a higher significance degree when displayed. The candidate accounts for transmitting the interaction request are recommended to the user based on different significance degrees, to improve the human-machine interaction efficiency.

In some embodiments, the plurality of candidate accounts are displayed by using a radar control, and an order of distances between the plurality of candidate accounts and a virtual radar in the radar control is consistent with the order of the plurality of candidate accounts.

In an example, referring to FIG. 5, a human-machine interaction interface 501 displays a radar control 502. The radar control 502 displays a candidate account 503 and a candidate account 505 of two other players. A physical distance between the candidate account 503 and the first account is less than a physical distance between the candidate account 505 and the first account. Therefore, a distance between the candidate account 503 and a virtual radar 506 is less than a distance between the candidate account 505 and the virtual radar 506.

In some embodiments, when the at least one candidate account is displayed, a countdown control is displayed, the countdown control being configured to start timing from the display of the at least one candidate account; and in response to that timing duration reaches a set duration threshold, and the at least one candidate account is in an unselected state, the at least one candidate account is hidden, and at least one new candidate account is displayed. Display duration of each batch of candidate accounts can be controlled in the embodiments of this disclosure, so that a batch of candidate accounts may be replaced for display at intervals, thereby providing more selections for logging in using the first account, and improving the human-machine interaction efficiency.

In an example, the countdown control may be a clock that is counting down, which starts timing from the display of the at least one candidate account, for example, starting countdown from 10 seconds. 10 seconds is a set duration threshold. In response to that timing duration reaches the set duration threshold, that is, all displayed candidate accounts are still unselected at the end of the countdown, all the candidate accounts displayed currently are hidden, and new candidate accounts are displayed. A manner of obtaining the new candidate accounts is similar to the above manner of obtaining the candidate accounts.

In some embodiments, the automatic selection condition includes at least one of the following: a number of candidate virtual objects associated with the candidate account is not less than a third number threshold, where the third number threshold is a difference between the number of attacking objects attacking the at least one first virtual object and a number of the at least one first virtual object; or an object skill of the candidate virtual object associated with the candidate account is different from an object skill of the at least one first virtual object.

In an example, the number of attacking objects is 10, the number of first virtual objects is 3, and the third number threshold is 7. A candidate account with the number of associated candidate virtual objects not less than 7 is automatically selected as the second account, to ensure that the second virtual object of the second account can effectively assist the first virtual object. When a skill of the candidate virtual object is different from a skill of the first virtual object, the skills can be complementary during assistance, to improve a subsequent interaction effect.

In some embodiments, when there are a plurality of second accounts, FIG. 3C is a schematic flowchart of a method for controlling an object in a virtual scene according to an embodiment of this disclosure. The controlling the at least one second virtual object respectively associated with the at least one second account to appear from the second position in operation 104 may be implemented through operation 1041 or operation 1042 in FIG. 3C.

Operation 1041: Control at least one second virtual object respectively associated with each second account to appear from a same second position.

In some embodiments, during the controlling the at least one second virtual object respectively associated with each second account to appear from the same second position, the second position satisfies at least one of the following conditions: the second position is any position away from the at least one first virtual object by a distance less than a first distance threshold, and the second virtual object can be controlled to appear near the first virtual object, and can randomly appear, preventing the attacking object from predicting a position from which the second virtual object appears in an attacking scene; when the first virtual object is in an attacked state, the second position is a position outside an attacking range of the attacking object, to ensure that the second virtual object is not attacked by the attacking object in an attacking scene; when the first virtual object is in an attacking state, the second position is a position within a damage range of an attacked object, to ensure that the attacked object can be effectively attacked in an attacking scene; or when there are a plurality of virtual items to be picked up in the virtual scene, the second position is any position away from the virtual item by a distance less than a fourth distance threshold. The fourth distance threshold is an average value of distances between each virtual object and a closest virtual item thereof in the virtual scene, facilitating the second virtual object quickly picking up the virtual item in an item sharing scene, to improve efficiency of picking up virtual items.

Operation 1042: Control the at least one second virtual object respectively associated with each second account to appear from different second positions, different second accounts corresponding to the different second positions.

In some embodiments, during the controlling the at least one second virtual object respectively associated with each second account to appear from the different second positions, for each second account, object data of the at least one second virtual object associated with the second account is obtained; interaction data of the virtual scene is obtained; and a plurality of position allocation policies for the plurality of second accounts are obtained, the position allocation policy including the second position corresponding to each second account. A second neural network model is invoked to perform the following processing: extracting an object feature of corresponding object data, an interaction feature of corresponding interaction data, and an allocation feature of each corresponding position allocation policy; merging the object feature, the interaction feature, and the allocation feature for each position allocation policy, to obtain a second merged feature, and mapping the second merged feature into an interaction result score, the interaction result score being an interaction result score obtained by displaying at least one second virtual object respectively associated with each second account according to the position allocation policy; and extracting the second position corresponding to each second account from a position allocation policy with a highest interaction result score. Therefore, the second neural network model can learn the current status of the virtual object and the current environment of the virtual scene, to accurately predict an interaction result score of applying each position allocation policy based on learned information. Because the interaction result score can be accurately predicted, a position allocation policy conducive to interaction can be provided, to improve the human-machine interaction efficiency and the interaction efficiency.

In an example, the environment data is configured for indicating topography of the virtual scene, and the object data is configured for indicating the current status of the virtual object, for example, a health point and a skill. Sample object data of a sample account is acquired in a sample virtual scene, and sample environment data is acquired in the sample virtual scene. A training sample is built according to acquired data, the training sample is used as an input of a to-be-trained second neural network model, and an actual interaction result score of each position allocation policy is used as annotation data. The second neural network model is trained based on the training sample and the annotation data, so that the position allocation policy can be directly determined by using the second neural network model.

In some embodiments, FIG. 3D is a schematic flowchart of a method for controlling an object in a virtual scene according to an embodiment of this disclosure. The controlling the at least one second virtual object respectively associated with the at least one second account to appear from the second position in operation 104 may be implemented by performing operation 1043 or operation 1044 in FIG. 3D for each second account.

Operation 1043: Generate at least one second virtual object associated with the second account at the second position.

Operation 1044: Control at least one second virtual object associated with the second account to disappear from a third position and appear from the second position in an instantaneous moving manner.

In an example, through operation 1043, the second virtual object can be directly generated at the second position out of nothing. By performing operation 1044, the second virtual object in the third position in the virtual scene can be transmitted to the second position through a virtual time tunnel, to implement instantaneous moving of the second virtual object. The second virtual object can directly appear at the second position through the above two implementations, breaking through the distance limitation and improving the interaction efficiency in the virtual scene.

In some embodiments, after controlling the at least one second virtual object respectively associated with the at least one second account to appear from the second position, the following processing is performed for each second account: controlling, in response to that a distance between the second terminal to which the second account is logged in and the first terminal exceeds the second distance threshold, at least one second virtual object associated with the second account to hide, to control the second terminal to always stay close to the first terminal, thereby linking online games with offline interactions to enhance the fun of interaction; and displaying prompt information in response to that the distance between the second terminal to which the second account is logged in and the first terminal exceeds a fifth distance threshold, and does not exceed the second distance threshold, the prompt information indicating that the first terminal to which the first account is logged in needs to be close to the second terminal, the fifth distance threshold being less than the second distance threshold, and the fifth distance threshold may be half the second distance threshold. When a distance between the second terminal and the first terminal gradually increases, and is to exceed the second distance threshold, the prompt information is displayed, to avoid direct disappearance of the second virtual object, thereby improving the interaction efficiency.

In some embodiments, after the at least one second virtual object respectively associated with the at least one second account at the second position of the virtual scene, the following processing is performed for each second account: displaying a social relationship portal corresponding to the second account; and transmitting a social relationship establishment request to the second account in response to a trigger operation for the social relationship portal. In the embodiments of this disclosure, the game interaction can be extended to the social interaction, to improve interaction diversity.

In some embodiments, FIG. 3E is a schematic flowchart of a method for controlling an object in a virtual scene according to an embodiment of this disclosure, which is described with reference to operation 201 to operation 203 shown in FIG. 3E.

Operation 201: Display the virtual scene in a human-machine interaction interface of a second terminal, a second account being logged in to the second terminal.

Operation 202: Display an interaction request transmitted by a first terminal, a first account being logged in to the first terminal.

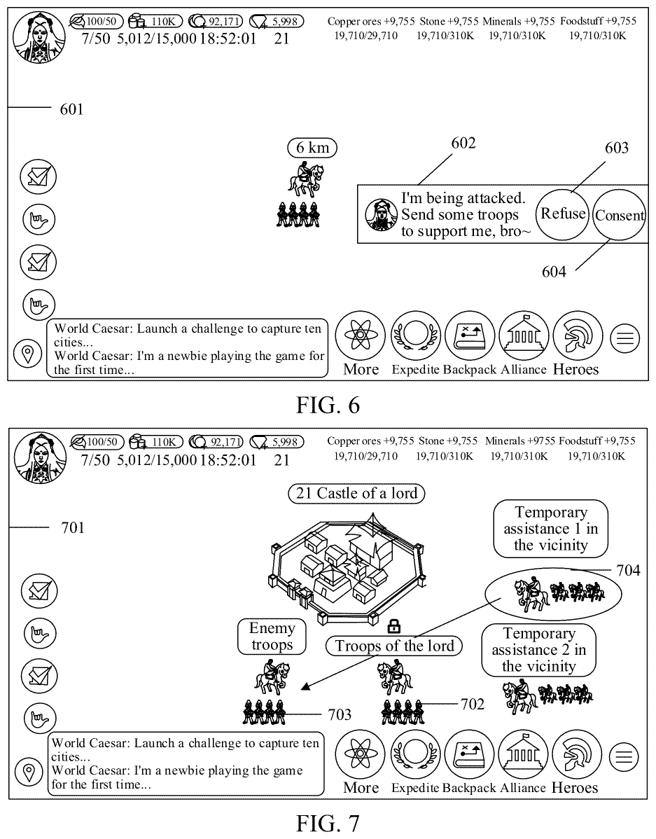

In an example, FIG. 6 is a schematic diagram of an interface of a method for controlling an object in a virtual scene according to an embodiment of this disclosure. A player B that receives an assistance request can see who transmits the assistance request. A human-machine interaction interface 601 of the player B displays a received assistance request 602, and a refusal control 603 and a consent control 604 are displayed in the assistance request 602. If the player B consents to assist, a preset second virtual object directly appears near a player A, and prompt information “Player A has been successfully supported” is displayed in the human-machine interaction interface. The player A or the player B can control the second virtual object (an assisting team) to attack, achieving an unexpected victory effect. When a plurality of players B near the player A consent to assist, a plurality of assisting teams are displayed near the first virtual object, namely, assisting teams respectively controlled by the plurality of players B respectively. Each assisting team may include one or more second virtual objects.

Operation 203: Control, in response to a confirm operation for the interaction request, at least one second virtual object associated with the second account to appear from a second position and interact with at least one first virtual object associated with the first account, a distance between the second position and a first position being less than a first distance threshold.

In an example, a specific implementation of the controlling the at least one second virtual object associated with the second account to appear from the second position and interact with the at least one first virtual object associated with the first account in operation 203 may refer to the implementation of operation 104, and the second virtual object appearing at the second position may be still controlled by the second account or may be controlled by the first account.

In the embodiments of this disclosure, the first account associated with the first virtual object is logged in to the first terminal. The first terminal transmits the interaction request to the second terminal. In response to that the second account being logged in to the second terminal receives the interaction request, the second virtual object associated with the second account appears near the first virtual object, and interacts with the first virtual object, which is equivalent to breaking through a distance limitation of inviting other virtual objects to interact, so that the second virtual object appears near the first virtual object in real time. Compared with a manner moving in the virtual scene, this can improve the interaction efficiency in the virtual scene and the human-machine interaction efficiency.

The following describes an example of the embodiments of this disclosure in an actual application scenario.

In some embodiments, the first account is logged in to a client (for example, an online game application) run on the first terminal. The virtual scene is displayed in the human-machine interaction interface of the first terminal. The virtual scene includes at least one first virtual object associated with the first account, and the at least one first virtual object is at the first position. The interaction invitation portal is displayed on the first terminal. In response to the trigger operation for the interaction invitation portal, the first terminal transmits the interaction request to the second terminal by the server. The second account is logged in to the second terminal. In response to that the second account receives the interaction request, the second terminal transmits the interaction reception instruction to the server. At least one second virtual object associated with the second account is generated by the server at the second position near the first virtual object, and interacts with the at least one first virtual object. The server transmits the display data that the second virtual object appears at the second position and the display data that the second virtual object interacts with the first virtual object to the first terminal and the second terminal.

In strategy games, a player may control a virtual object to fight in the game by being logged in to an account. In processes of battle preparation and battle, to improve the fun of the game, players interact with each other by controlling virtual objects, for example, an assistance interaction. For victory of the battle, an aid team or a helper is often recruited to achieve the goal of victory. However, the battle situation changes rapidly. During the battle, one player sending an aid team to another player for assistance can often have a decisive impact on the battle, and increase a probability of victory.

First, the player A is logged into a first account A for gaming, and the first virtual object controlled by the first account A is being attacked. FIG. 4 is a schematic diagram of an interface of a method for controlling an object in a virtual scene according to an embodiment of this disclosure. The human-machine interaction interface 401 displays the first virtual object 403 attacked by the third virtual object 402. The human-machine interaction interface 401 further displays the battle assistance request portal 404. In this case, the first account may perform a trigger operation for the battle assistance request portal 404.

FIG. 5 is a schematic diagram of an interface of a method for controlling an object in a virtual scene according to an embodiment of this disclosure. After the first account performs the trigger operation for the battle assistance request portal 404 in FIG. 4, based on a near field communication technology, another player B near the player A can be identified. For example, the human-machine interaction interface 501 displays the radar control 502. The radar control 502 displays the account profile pictures 503 of two other players and the interaction request control 504. In response to the trigger operation by the first account for the interaction request control 504, the assistance request can be transmitted to other players near the player A in the real world.

Then, FIG. 6 is a schematic diagram of an interface of a method for controlling an object in a virtual scene according to an embodiment of this disclosure. The player B that receives the assistance request can see who transmits the assistance request. The human-machine interaction interface 601 of the player B displays the received assistance request 602, and the refusal control 603 and the consent control 604 are displayed in the assistance request 602. If the player B consents to assist, the preset second virtual object directly appears near the player A, and the prompt information “Player A has been successfully supported” is displayed in the human-machine interaction interface. The player A or the player B can control the second virtual object (the assisting team) to attack, achieving an unexpected victory effect. When the plurality of players B near the player A consent to assist, the plurality of assisting teams are displayed near the first virtual object, namely, assisting teams respectively controlled by the plurality of players B respectively. Each assisting team may include one or more second virtual objects.

Finally, FIG. 7 is a schematic diagram of an interface of a method for controlling an object in a virtual scene according to an embodiment of this disclosure. A human-machine interaction interface 701 displays a first virtual object 702, a third virtual object 703 that attacks the first virtual object 702, and a second virtual object 704 that assists the first virtual object 702. The second virtual object 704 appears near the first virtual object out of nothing. The first virtual object and the second virtual object can jointly fight with the third virtual object.

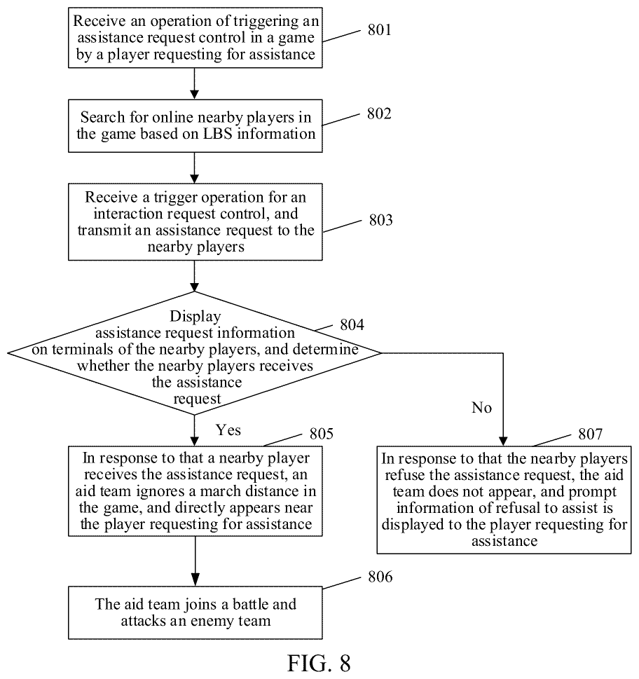

In some embodiments, location is performed mainly by geographical position information. The geographical position information may be an actual position, or may be a virtual position set by a player for protecting privacy. FIG. 8 is a schematic flowchart of a method for controlling an object in a virtual scene according to an embodiment of this disclosure.

Operation 801: Receive an operation of triggering an assistance request control in a game by a player requesting for assistance.

Operation 802: Search for online players near the player requesting for assistance based on LBS information, and specifically, determine geographical position coordinates of a mobile phone based on a global positioning system, and discover the nearby players in the game by computing geographical position information of a mobile phone and mobile phones of surrounding players.

Operation 803: Receive a trigger operation for an interaction request control, and transmit an assistance request to the nearby players.

Operation 804: Display assistance request information on terminals of the nearby players, and determine whether the nearby players receives the assistance request.

Operation 805: In response to that a nearby player receives the assistance request, an aid team ignores a march distance in the game, and directly appears near the player requesting for assistance.

Operation 806: The aid team joins a battle and attacks an enemy team, and specifically, the aid team may be controlled by the player requesting for assistance or the nearby player.

Operation 807: In response to that the nearby players refuse the assistance request, the aid team does not appear, and prompt information of refusal to assist is displayed to the player requesting for assistance.

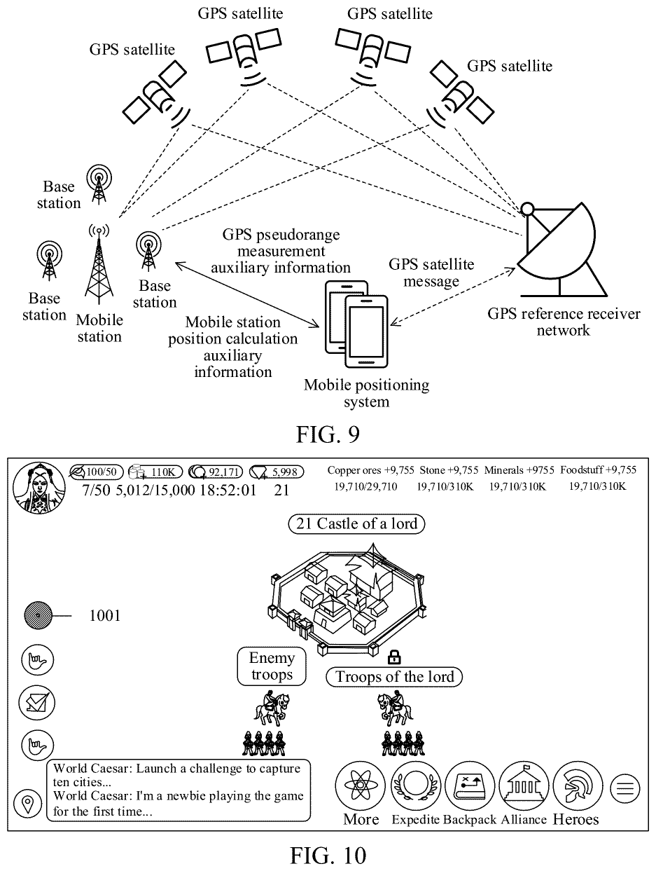

In some embodiments, FIG. 9 is a schematic diagram of positioning of a method for controlling an object in a virtual scene according to an embodiment of this disclosure. Mobile phone location technologies mainly include the following types: 1. satellite positioning technology; 2. mobile base station positioning technology; 3. wireless fidelity positioning technology; and 4. assisted satellite positioning technology.

In the satellite positioning technology, a positioning satellite records a time it takes to transmit and receive a signal to a mobile phone of a user, to calculate a distance between the satellite and the mobile phone of the user, and data from a plurality of satellites are integrated to locate a specific position of the mobile phone of the user.

In the mobile base station positioning technology, a principle is mainly three-point positioning, the mobile phone of the user is registered to surrounding base stations after being powered on, and at the same time, the mobile phone measures downlink guide frequency signals of different base stations to get arrival moments of the signals of the base stations and an arrival time difference, and then compares position coordinate data of the base stations to correct position data of the mobile phone itself.

In the wireless fidelity positioning technology, a principle of the wireless fidelity positioning technology is similar to that of the mobile base station positioning, which is based on the three-point location based on nearby stations with known locations, but in the wireless fidelity positioning technology, a wireless access point acts as a mobile base station and moves the base station indoors.

In the assisted satellite positioning technology, this positioning method is actually an enhanced version of the satellite positioning technology, which is a technology that combines network base station information and satellite positioning information to quickly locate a mobile device, using location information of a mobile phone base station with conventional positioning satellites to make the positioning faster.

In the embodiments of this disclosure, assistance request can be transmitted to online nearby players, to quickly recruit an aid team. The aid team directly appears near an assisted object, and can quickly join a battle, to win the battle surprisingly, and effectively reduce time consumed in the game due to march based on an actual map. In addition, seeking nearby players for support based on LBS can quickly recruit a plurality of aid teams, effectively enhancing offline interactions and enriching game interaction diversity.

The embodiments of this disclosure are widely applied to the strategy games. Compared with an original march manner based on a game geographical position and a map, seeking the aid teams based on the satellite positioning technology can promote diversity of a battle process, significantly improve playability and strategy, and promote interactions between offline players such as cooperation.

In the embodiments of this disclosure, related data such as user information is involved. When the embodiments of this disclosure are applied to specific products or technologies, user permission or consent needs to be obtained, and the collection, use, and processing of relevant data need to comply with relevant laws, regulations, and standards of related countries and regions.

The following continues to describe an example structure of the apparatus 455-1 for controlling an object in a virtual scene implemented as a software module provided in the embodiments of this disclosure. In some embodiments, as shown in FIG. 2A, the software modules in the apparatus 455-1 for controlling an object in a virtual scene stored in the memory 450 may include: a first display module 4551, configured to display the virtual scene in a human-machine interaction interface of a first terminal, a first account being logged in to the first terminal, the virtual scene including at least one first virtual object associated with the first account, and the at least one first virtual object being at a first position; a second display module 4552, configured to display an interaction invitation portal; a transmitting module 4553, configured to transmit an interaction request to at least one second terminal in response to a trigger operation for the interaction invitation portal, different second accounts being logged in to different second terminals; and a first interaction module 4554, configured to control, in response to that at least one second account receives the interaction request, at least one second virtual object respectively associated with the at least one second account to appear from a second position and interact with the at least one first virtual object, a distance between the second position and the first position being less than a first distance threshold.

In some embodiments, the second display module 4552 is further configured to perform any one of the following processing: displaying the interaction invitation portal in the human-machine interaction interface when an interaction condition is satisfied; or continuously displaying the interaction invitation portal in the human-machine interaction interface, and in a process of continuously displaying the interaction invitation portal, highlighting the interaction invitation portal when the interaction condition is satisfied.

In some embodiments, the interaction condition includes at least one of the following: a total health point of the at least one first virtual object is less than a health threshold; the at least one first virtual object is in an attacked state, and a number of attacking objects exceeds a first number threshold; the at least one first virtual object is in a battle interaction victory state; or a number of virtual items to be picked up in the virtual scene exceeds a second number threshold.

In some embodiments, the transmitting module 4553 is further configured to: display at least one candidate account, and display an interaction request control; and use, in response to a trigger operation for the interaction request control, the at least one candidate account as at least one second account, and transmit the interaction request to the at least one second terminal to which the at least one second account is logged in respectively.

In some embodiments, the transmitting module 4553 is further configured to: display at least one candidate account, and display an interaction request control; display, in response to a selecting operation for at least one candidate account or that at least one candidate account satisfies an automatic selection condition, that the at least one candidate account is in a selected state; and use, in response to a trigger operation for the interaction request control, the candidate account in the selected state as a second account, and transmit the interaction request to the at least one second terminal to which the at least one second account is logged in.

In some embodiments, the transmitting module 4553 is further configured to: display a countdown control when the at least one candidate account is displayed, the countdown control being configured to start timing from the display of the at least one candidate account; and hide, in response to that timing duration reaches a set duration threshold, and the at least one candidate account is in an unselected state, the at least one candidate account is hidden, and display at least one new candidate account.

In some embodiments, the automatic selection condition includes at least one of the following: a number of candidate virtual objects associated with the candidate account is not less than a third number threshold, where the third number threshold is a difference between the number of attacking objects attacking the at least one first virtual object and a number of the at least one first virtual object; or an object skill of the candidate virtual object associated with the candidate account is different from an object skill of the at least one first virtual object.

In some embodiments, before the at least one candidate account is displayed, the transmitting module 4553 is further configured to obtain a candidate account satisfying at least one of the following screening conditions: a distance between a terminal to which a candidate account is logged in and the first terminal is less than a second distance threshold; a candidate account having a social relationship with the first account; a candidate account having a historical interaction event with the first account in the virtual scene; or a distance between a candidate virtual object associated with the at least one candidate account and the at least one first virtual object is less than a third distance threshold.

In some embodiments, before the at least one candidate account is displayed, the transmitting module 4553 is further configured to: obtain environment data of the virtual scene and object data of at least one virtual object associated with each participating account in the virtual scene; and invoke a first neural network model to perform the following processing: extracting an environment feature from the environment data, and extracting an object feature from the object data; merging the environment feature and the object feature, to obtain a first merged feature; and mapping the first merged feature into a first probability of each participating account responding to the interaction request, and using a participating account whose first probability is greater than a first probability threshold as the candidate account.

In some embodiments, when there are a plurality of candidate accounts, the transmitting module 4553 is further configured to perform any one of the following processing: displaying the plurality of candidate accounts in ascending order of physical distances between the plurality of candidate accounts and the first account, the physical distance between the candidate account and the first account being a distance between a candidate terminal to which the candidate account is logged in and the first terminal; displaying the plurality of candidate accounts in ascending order of social distances between the plurality of candidate accounts and the first account; displaying the plurality of candidate accounts in ascending order of network signal strengths of terminals to which the plurality of candidate accounts are logged in; or displaying candidate accounts in descending order of significance degrees of the candidate accounts. The significance degree of the candidate account is negatively correlated to a feature parameter of the candidate account. The feature parameter includes at least one of the following: the physical distance between the terminal to which the candidate account is logged in and the first terminal, the social distance between the candidate account and the first account, or the distance between the candidate virtual object associated with the candidate account and the first virtual object.

In some embodiments, the first account and the plurality of candidate accounts are displayed by using a radar control. The first account is displayed at the center of the radar control, and the plurality of candidate accounts are arranged in sequence.

In some embodiments, when there are a plurality of second accounts, the first interaction module 4554 is further configured to perform any one of the following processing: controlling at least one second virtual object respectively associated with each second account to appear from a same second position; or controlling at least one second virtual object respectively associated with each second account to appear from different second positions, different second accounts corresponding to different second positions.

In some embodiments, during the controlling the at least one second virtual object respectively associated with each second account to appear from the same second position, the second position satisfies at least one of the following conditions: the second position is any position away from the at least one first virtual object by a distance less than the first distance threshold; when the first virtual object is in an attacked state, the second position is a position outside an attacking range of an attacking object; when the first virtual object is in an attacking state, the second position is a position within a damage range of an attacked object; or when there are a plurality of virtual items to be picked up in the virtual scene, the second position is any position away from the virtual item by a distance less than a fourth distance threshold.

In some embodiments, during the controlling the at least one second virtual object respectively associated with each second account to appear from different second positions, the first interaction module 4554 is further configured to: obtain, for each second account, object data of at least one second virtual object associated with the second account; obtain interaction data of the virtual scene; obtain a plurality of position allocation policies for the plurality of second accounts, the position allocation policy including the second position corresponding to each second account; and invoke a second neural network model to perform the following processing: extracting an object feature of corresponding object data, an interaction feature of corresponding interaction data, and an allocation feature of each corresponding position allocation policy; merging the object feature, the interaction feature, and the allocation feature for each position allocation policy, to obtain a second merged feature, and mapping the second merged feature into an interaction result score, the interaction result score being an interaction result score obtained by displaying at least one second virtual object respectively associated with each second account according to the position allocation policy; and extracting the second position corresponding to each second account from a position allocation policy with a highest interaction result score.

In some embodiments, the first interaction module 4554 is further configured to perform any one of the following processing for each second account: generating at least one second virtual object associated with the second account at the second position; or controlling at least one second virtual object associated with the second account to disappear from a third position and appear from the second position in an instantaneous moving manner.

In some embodiments, after controlling the at least one second virtual object respectively associated with the at least one second account to appear from the second position, the first interaction module 4554 is further configured to perform the following processing for each second account: controlling, in response to that a distance between the second terminal to which the second account is logged in and the first terminal exceeds the second distance threshold, at least one second virtual object associated with the second account to hide; and displaying prompt information in response to that the distance between the second terminal to which the second account is logged in and the first terminal exceeds a fifth distance threshold, and does not exceed the second distance threshold, the prompt information indicating that the first terminal to which the first account is logged in needs to be close to the second terminal, and the fifth distance threshold being less than the second distance threshold.

In some embodiments, after the at least one second virtual object respectively associated with the at least one second account appears at the second position of the virtual scene, the first interaction module 4554 is further configured to perform the following processing for each second account: displaying a social relationship portal corresponding to the second account; and transmitting a social relationship establishment request to the second account in response to a trigger operation for the social relationship portal.

An embodiment of this disclosure provides an apparatus 455-2 for controlling an object in a virtual scene. The apparatus 455-2 includes: a third display module 4555, configured to display the virtual scene in a human-machine interaction interface of a second terminal, a second account being logged in to the second terminal; a receiving module 4556, configured to display an interaction request transmitted by a first terminal, a first account being logged in to the first terminal; and a second interaction module 4557, configured to control, in response to a confirm operation for the interaction request, at least one second virtual object associated with the second account to appear from a second position and interact with at least one first virtual object associated with the first account, a distance between the second position and a first position being less than a first distance threshold.

An embodiment of this disclosure provides a computer program product. The computer program product includes computer-executable instructions, and the computer-executable instructions are stored in a computer-readable storage medium. A processor of an electronic device reads the computer-executable instructions from the computer-readable storage medium, and executes the computer-executable instructions, to cause the electronic device to perform the method for controlling an object in a virtual scene according to the embodiments of this disclosure.

An embodiment of this disclosure provides a computer-readable storage medium having computer-executable instructions stored therein. When the computer-executable instructions are executed by a processor, the processor is caused to perform the method for controlling an object in a virtual scene provided in the embodiments of this disclosure, for example, the method for controlling an object in a virtual scene shown in FIG. 3A to FIG. 3E.

In some embodiments, the computer-readable storage medium may be a memory such as an FRAM, a ROM, a PROM, an EPROM, an EEPROM, a flash memory, a magnetic surface memory, an optical disk, or a CD-ROM, or may be any device including one of or any combination of the foregoing memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a HyperText Markup Language (HTML) file, stored in a file that is specially used for a program in discussion, or stored in a plurality of collaborative files (for example, be stored in files of one or more modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

For example, in embodiments of this disclosure, the first account associated with the first virtual object is logged in to the first terminal. The first terminal transmits the interaction request to the second terminal. In response to that the second account being logged in to the second terminal receives the interaction request, the second virtual object associated with the second account appears near the first virtual object, and interacts with the first virtual object, which is equivalent to breaking through the distance limitation of inviting other virtual objects to interact, so that the second virtual object appears near the first virtual object in real time. Compared with a manner moving in the virtual scene, this can improve the interaction efficiency in the virtual scene and the human-machine interaction efficiency.

The foregoing descriptions are merely examples of embodiments of this disclosure and are not intended to limit the protection scope of this disclosure. Any modification, equivalent replacement, or improvement made without departing from the spirit and range of this disclosure shall fall within the protection scope of this disclosure.

What is claimed is:

1. A method for controlling a virtual object, the method comprising:
displaying a virtual scene by a first terminal, a first account being logged in to the first terminal, the virtual scene including at least one first virtual object at a first position and associated with the first account;
displaying an interaction invitation interface; and
transmitting an interaction request to at least one second terminal in response to a trigger operation being performed on the interaction invitation interface, wherein
each of the at least one second terminal is associated with a different second account and
each of at least one second virtual object is controlled to interact with the at least one first virtual object in response to the interaction request and based on whether a distance between a second position of the respective second virtual object and the first position is less than a first distance threshold.

2. The method according to claim 1, wherein the displaying the interaction invitation interface comprises:
displaying an interaction invitation interface access element when an interaction condition is satisfied; or
continuously displaying the interaction invitation interface access element and highlighting the interaction invitation interface when an interaction condition is satisfied.

3. The method according to claim 2, wherein the interaction condition comprises at least one of:
a total health point of the at least one first virtual object is less than a health threshold;
the at least one first virtual object is in an attacked state, and a number of attacking objects exceeds a attack threshold;
the at least one first virtual object is in a battle interaction victory state; or
a number of virtual items to be picked up in the virtual scene exceeds a pick up threshold.

4. The method according to claim 1, wherein the transmitting the interaction request to the at least one second terminal comprises:
displaying at least one candidate account element and an interaction request control element;
configuring, in response to a trigger operation being performed on the interaction request control element, at least one candidate account corresponding to the at least one candidate account element as at least one second account; and
transmitting the interaction request to the at least one second terminal to which the at least one second account is logged in.

5. The method according to claim 1, wherein the transmitting the interaction request to the at least one second terminal comprises:
displaying at least one candidate account element and an interaction request control element;
displaying, in response to at least one candidate account corresponding to the at least one candidate account element satisfying an automatic selection condition, the at least one candidate account in a selected state;
configuring, in response to a trigger operation being performed on the interaction request control element, the candidate account in the selected state as a second account; and
transmitting the interaction request to the at least one second terminal to which the at least one second account is logged in.

6. The method according to claim 5, wherein the method further comprises:
displaying a countdown for the at least one candidate account;
hiding, when the countdown reaches a set duration threshold and the at least one candidate account is in an unselected state, the at least one candidate account; and
displaying at least one new candidate account.

7. The method according to claim 5, wherein:
a number of candidate virtual objects associated with the candidate account is greater than a difference between a number of attacking objects attacking the at least one first virtual object and a number of the at least one first virtual object; or
an object skill of the candidate virtual object associated with the candidate account is greater than an object skill of the at least one first virtual object.

8. The method according to claim 4, wherein the method further comprises:
obtaining a candidate account satisfying at least one of:
a distance between a terminal which a candidate account is logged in and the first terminal is less than a second distance threshold;
a candidate account having a social relationship with the first account;
a candidate account having a historical interaction event with the first account in the virtual scene; or
a distance between a candidate virtual object associated with the at least one candidate account and the at least one first virtual object is less than a third distance threshold.

9. The method according to claim 4, wherein the method further comprises:
obtaining environment data of the virtual scene and object data of at least one virtual object; and
invoking a first neural network model to perform:
extracting an environment feature from the environment data, and extracting an object feature from the object data;
merging the environment feature and the object feature, to obtain a first merged feature; and
mapping the first merged feature into a first probability of each participating account responding to the interaction request and using a participating account with highest probability as the candidate account.

10. The method according to claim 4, wherein the method further comprises:
displaying a plurality of candidate accounts in ascending order of physical distances between a candidate terminal to which the candidate account is logged in and the first terminal;
displaying the plurality of candidate accounts in ascending order of social distances between the plurality of candidate accounts and the first account; or
displaying the plurality of candidate accounts in ascending order of network signal strengths of terminals which the plurality of candidate accounts are logged in.

11. The method according to claim 10, wherein
the plurality of candidate accounts are displayed by using a virtual radar and in an ascending order.

12. The method according claim 1, wherein when a plurality of second accounts are provided, the method further comprises:
controlling the at least one second virtual object associated with each second account to appear from a same second position; or
controlling the at least one second virtual object associated with each second account to appear from different second positions.

13. The method according to claim 12, wherein
the second position is any position away from the at least one first virtual object by a distance less than the first distance threshold;
when the first virtual object is in an attacked state, the second position is a position outside an attacking range of an attacking object;
when the first virtual object is in an attacking state, the second position is a position within a damage range of an attacked object; or
when a plurality of virtual items to be picked up are provided in the virtual scene, the second position is any position away from a virtual item of the plurality of virtual items by a distance less than a fourth distance threshold.

14. An apparatus, the apparatus comprising:
processing circuitry configured to:
display a virtual scene, a first account being logged in to the apparatus, the virtual scene including at least one first virtual object at a first position and associated with the first account;
display an interaction invitation interface; and
transmit an interaction request to at least one second terminal in response to a trigger operation being performed on the interaction invitation interface, wherein
each of the at least one second terminal is associated with a different second accounts, and
each of at least one second virtual object is controlled to interact with the at least one first virtual object in response to the interaction request and based on whether a distance between a second position of the respective second virtual object and the first position is less than a first distance threshold.

15. The apparatus according to claim 14, wherein the processing circuitry configured to:
display an interaction invitation interface access element when an interaction condition is satisfied; or
continuously display the interaction invitation interface access element and highlight the interaction invitation interface when the interaction condition is satisfied.

16. The apparatus according to claim 15, wherein the interaction condition comprises at least one of:
a total health point of the at least one first virtual object is less than a health threshold;
the at least one first virtual object is in an attacked state, and a number of attacking objects exceeds a attack threshold;
the at least one first virtual object is in a battle interaction victory state; or
a number of virtual items to be picked up in the virtual scene exceeds a pick up threshold.

17. The apparatus according to claim 14, wherein the processing circuitry configured to:
display at least one candidate account element and an interaction request control element;
configure, in response to a trigger operation being performed on the interaction request control element, at least one candidate account corresponding to the at least one candidate account element as at least one second account; and
transmit the interaction request to the at least one second terminal to which the at least one second account is logged in.

18. A non-transitory computer-readable storage medium, storing instructions which when executed by a processor cause the processor to perform:
displaying a virtual scene, a first account being logged in, the virtual scene including at least one first virtual object at a first position and associated with the first account;
displaying an interaction invitation interface; and
transmitting an interaction request to at least one second terminal in response to a trigger operation being performed on the interaction invitation interface, wherein
each of the at least one second terminal is associated with a different second accounts, and
each of at least one second virtual object is controlled to interact with the at least one first virtual object in response to the interaction request and based on whether a distance between a second position of the respective second virtual object and the first position is less than a first distance threshold.

19. The non-transitory computer-readable storage medium according to claim 18, wherein the instructions when executed by the processor further cause the processor to perform:
displaying an interaction invitation interface access element when an interaction condition is satisfied; or
continuously displaying the interaction invitation interface access element and highlighting the interaction invitation interface when an interaction condition is satisfied.

20. The non-transitory computer-readable storage medium according to claim 19, wherein the interaction condition comprises at least one of:
a total health point of the at least one first virtual object is less than a health threshold;
the at least one first virtual object is in an attacked state, and a number of attacking objects exceeds a attack threshold;
the at least one first virtual object is in a battle interaction victory state; or
a number of virtual items to be picked up in the virtual scene exceeds a pick up threshold.
